(19) United States
(12) Patent Application Publication
(10) Pub. No.: US 2026/0218823 A1
(43) Pub. Date: Jul. 30, 2026

(54) GIMBAL COMPENSATOR

(71) Applicant: TUBIFLEX S.P.A., Torino (TO) (IT)

(72) Inventors: Fulvio BRUNELLI, Torino (TO) (IT); Silvio CORRIAS, Torino (TO) (IT)

(21) Appl. No.: 19/141,373

(22) PCT Filed: Dec. 21, 2023
(86) PCT No.: PCT/IB2023/063118

§ 371 Date: Jun. 20, 2025

(30) Foreign Application Priority Data
Dec. 22, 2022 (IT) 102022000026562

(51) Int. Cl. F16L 27/08; B33Y 80/00

(52) U.S. Cl. CPC F16L 27/0857; B33Y 80/00

(57) ABSTRACT

A gimbal compensator (10; 110) for sealingly connecting a pair of pipes in a pipeline is provided. The gimbal compensator (10) includes a first tubular element (20) and a second tubular element (30), a gimbal joint (40; 140) configured to couple the first tubular element (20) and the second tubular element (30), a bellows (50), and a first spacer element (29) and a second spacer element (39). The first and second spacer elements (29, 39) are annular and associated with the first tubular element (20) and the second tubular element (30), respectively. The bellows (50) is sealingly mounted to the first spacer element (29) and the second spacer element (39), each spacer element (29, 39) being made in one piece with the respective tubular element (20, 30) by the additive manufacturing technique.

### DESCRIPTION

### Technical Field

The present invention relates to a gimbal compensator configured for sealingly connecting a pair of pipes in a pipeline and to compensate for any movement of said pipes relative to each other.

The present invention further relates to a method of making such gimbal compensator.

The gimbal compensator according to the invention finds particular application in the aeronautical sector.

### Background Art

In various industries, including the aeronautical sector, there is a need to sealingly connect pairs of pipes in a pipeline that may be subject to relative movement with respect to each other.

Such need can be met by using gimbal compensators. Such compensators generally comprise two tubular elements (also referred to as clevises) apt to be connected to respective pipes in a pipeline and connected to each other by means of a gimbal joint comprising a coupling ring and two pairs of pins. Both the tubular elements and the coupling ring are provided with holes in which the pins for connecting the tubular elements to the coupling ring are inserted. Washers are also provided, between the tubular elements and the pins, in order to improve locking of said pins. The compensators further comprise a bellows, preferably made of a metal sheet, sealingly connected to both tubular elements. In particular, in those compensators in which the bellows is mounted outside with respect to the gimbal joint, the bellows is sealingly mounted to two annular spacer elements, each of which in turn is sealingly mounted to a respective one of said tubular elements.

Such known compensators cannot connect two pipes while compensating any tilting movement of the longitudinal axis of one of the pipes relative to the longitudinal axis of the other pipe. In particular, such gimbal compensators make it possible to effect an angular compensation within a certain solid angle (for example, within a cone with an apex angle in the order of ±6° or even larger) and at the same time prevent, thanks to the gimbal joint, movement of the pipes in the axial direction.

In the aeronautical sector, such gimbal compensators are used, mainly on fixed-wing aircrafts, in pipes of venting pneumatic systems (or bleed systems) apt to bleed out air from the compressor of the aircraft engine in order to supply various utilities of the aircraft, for example, gearboxes and anti-frost systems. These pipes are in fact subject to considerable stresses due to the high-pressure and high-temperature gases passing therethrough, and in general due to the vibrations to which the aircraft is subjected, especially during the take-off and landing phases.

A drawback of known compensators is that they include a large number of components and therefore require a lot of welding, particularly between tubular elements and spacer elements and between tubular elements and washers.

A further drawback of known compensators concerns the lack of coaxiality that often occurs between the spacer elements and the bellows.

The main object of the present invention is to overcome the drawbacks of prior art, by providing a gimbal compensator that comprises a reduced number of components.

A further object of the present invention is to eliminate or limit the prior art problems of lack of coaxiality.

These and other objects are achieved by the gimbal compensator and the method of making as claimed in the appended claims.

### SUMMARY OF INVENTION

A gimbal compensator according to the invention for sealingly connecting a pair of pipes in a pipeline comprises:
a first tubular element and a second tubular element,
a gimbal joint configured to couple the first tubular element and the second tubular element,
a bellows, and
a first spacer element and a second spacer element, said first and second spacer elements being annular and associated with the first tubular element and the second tubular element, respectively.

The bellows is sealingly mounted, for example, by welding, to the first spacer element and the second spacer element.

Each spacer element is made in one piece with the respective tubular element by the additive manufacturing technique.

The gimbal joint comprises a coupling ring having four holes, arranged at approximately 90° to each other along the circumferential direction of the ring, and four respective connection assemblies.

Each tubular element comprises a first coupling portion and a second coupling portion, diametrically opposed to each other, each provided with a respective hole.

Each of said four connection assemblies of the gimbal joint is configured to engage in one of the holes of the coupling portions of the tubular elements and in a respective hole of the coupling ring, so as to make the connection between each tubular element and the coupling ring.

Each of the holes of the coupling portions of the tubular elements is associated with a respective washer apt to cooperate with one respective connection assembly of said four connection assemblies.

Preferably, the washers are made in one piece with the respective tubular elements by the addictive manufacturing technique.

The bellows is preferably located outside the gimbal joint, thereby forming a gimbal compensator of the type with internal bracing, because the gimbal joint is located internally with respect to the bellows.

The spacer elements are preferably located on the outside of the respective tubular elements, in order to space the bellows from the gimbal joint.

Preferably, each spacer element has a “C”-shaped cross-section facing either a first end of the respective tubular element, i.e., the tubular element end connectable to a respective pipe of the pair of pipes to be connected, or a second end, opposite to said first end, of the respective tubular element. Alternatively, the spacer element has a cross-section with different shape, for example, a “Z”-shaped or “I”-shaped cross-section.

A method according to the invention for making the gimbal compensator illustrated above provides for the steps of:
providing a first tubular element and a second tubular element, a gimbal joint configured to couple the first tubular element and the second tubular element, and a bellows,
making the first tubular element in one piece with a respective spacer element, by the additive manufacturing technique,
making the second tubular element in one piece with a respective spacer element, by the additive manufacturing technique.

Preferably, the method further comprises the steps of:
making the first tubular element in one piece with respective washers, by the additive manufacturing technique,
making the second tubular element in one piece with respective washers, by the additive manufacturing technique.

In case, the method of making may further provide that other components of the gimbal compensator, for example, the pins and washers of the gimbal joint, are also made by the additive manufacturing technique.

The making of the tubular elements in one piece with the respective spacer elements and the respective washers advantageously makes it possible to reduce the overall number of components of the compensator, thereby allowing to achieve lower operating costs and shorter lead times, mitigating the risk of non-concurrent procurement of the various components.

The making of the tubular elements in one piece with the respective spacer elements and the respective washers further makes it possible to reduce welding of the compensator, thereby achieving a lower thermal distortion of the components and eliminating or limiting the need for geometrically remachining the coaxiality between the bushings and the respective holes in which they are inserted as well as the coaxiality between the bellows and the spacer elements.

In addition, the use of the additive manufacturing technique for making the tubular elements, the spacer elements and the washers provides for the possibility of easily customizing the geometry of said components to achieve greater strength thereof for the same weight, or to achieve a lower weight while guaranteeing structural strength, or to facilitate assembly and welding to the other components of the compensator and the pipes to be connected.

### BRIEF DESCRIPTION OF DRAWINGS

These and other features and advantages of the present invention will become more evident from the ensuing detailed description of preferred embodiments of the invention, given by way of non-limiting examples with reference to the annexed drawings, in which:

FIG. 1 is a sectional front view of a gimbal compensator according to an embodiment of the present invention;

FIG. 2 is a sectional perspective view of the gimbal compensator according to an embodiment of the present invention;

FIG. 3 is an exploded perspective view of the gimbal compensator according to an embodiment of the present invention;

FIG. 4 is a sectional front view of a gimbal compensator according to a further embodiment of the present invention.

### DESCRIPTION OF EMBODIMENTS

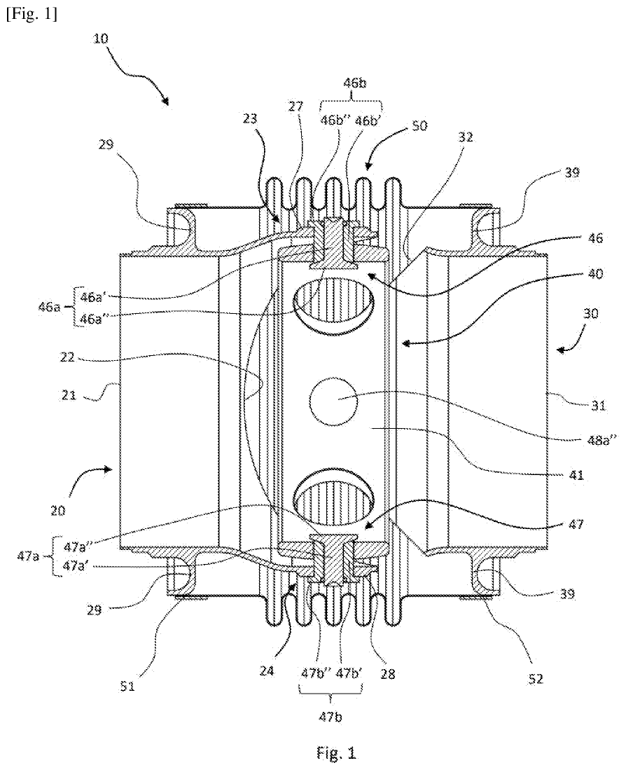

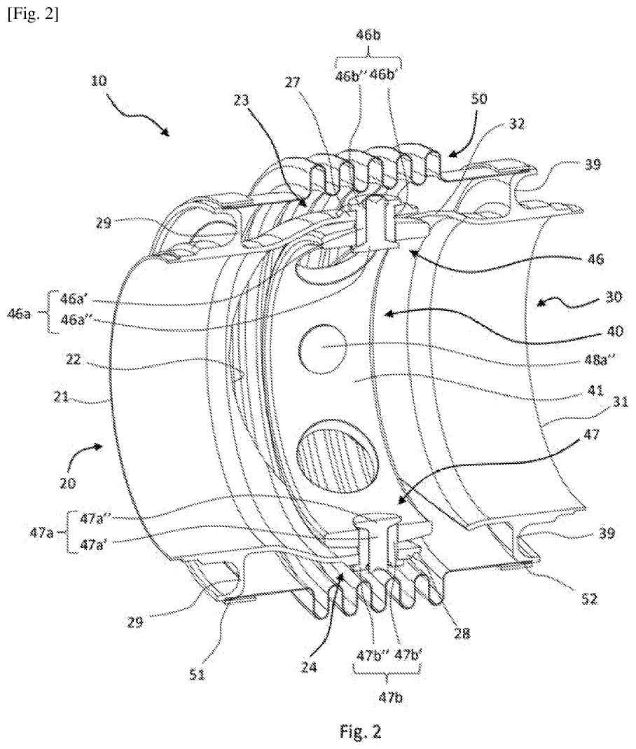

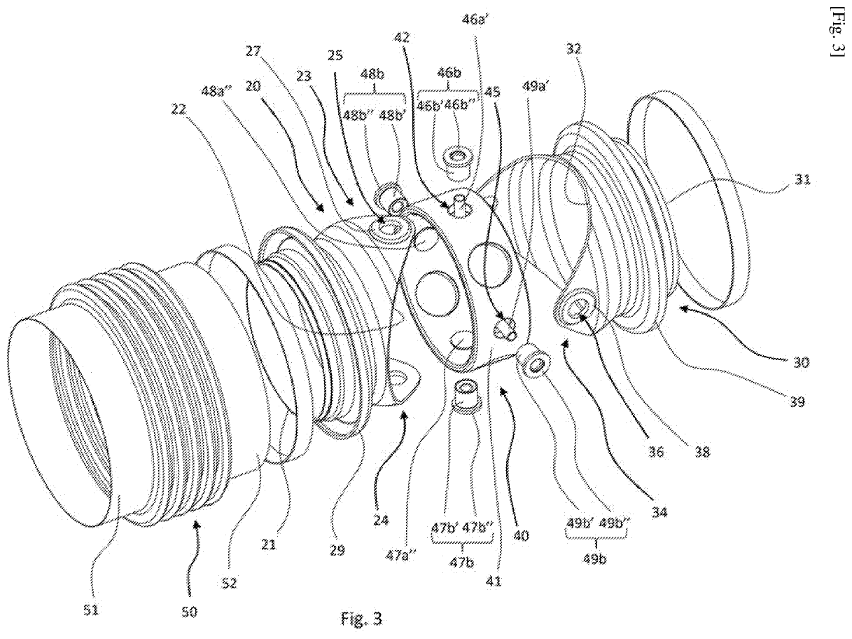

Referring to FIGS. 1, 2 and 3, an embodiment of a gimbal compensator 10 configured for sealingly connecting a pair of pipes (not shown) in a pipeline is illustrated below.

The gimbal compensator 10 comprises a first tubular element 20 and a second tubular element 30, which are coupled to each other by means of a gimbal joint 40.

The first tubular element 20 comprises a first end 21, connectable to a respective pipe of the pair of pipes to be connected, and a second end 22 having a first coupling portion 23 and a second coupling portion 24, diametrically opposed to each other, each provided with a respective hole 25, 26.

Likewise, the second tubular element 30 comprises a first end 31, connectable to a respective pipe of the pair of pipes to be connected, and a second end 32 having a first coupling portion 33 and a second coupling portion 34, diametrically opposed to each other, each provided with a respective hole 35, 36.

The gimbal joint 40 comprises a coupling ring 41 having four holes 42, 43, 44, 45, arranged at approximately 90° to each other along the circumferential direction of the ring 41, and four respective connection assemblies 46, 47, 48, 49, each comprising a pin 46a, 47a, 48a, 49a associated with a bushing 46b, 47b, 48b, 49b.

The first tubular element 20 is arranged so that its coupling portions 23, 24 and the respective holes 25, 26 are aligned with a first hole 42 and a second hole 43, diametrically opposite, of said four holes of the coupling ring 41.

Likewise, the second tubular element 30 is arranged so that its coupling portions 33, 34 and the respective holes 35, 36 are aligned with a third hole 44 and a fourth hole 45, diametrically opposite, of said four holes of the coupling ring 41.

Each of said four connection assemblies 46, 47, 48, 49 of the gimbal join 40 is configured to engage in one of the holes 25, 26, 35, 36 of the coupling portions 23, 24, 33, 34 of the tubular elements 20, 30 and in a respective hole 42, 43, 44, 45 of the coupling ring 41, so as to make the connection between each tubular element 20, 30 and the coupling ring 41. In particular, the bushing 46b, 47b, 48b, 49b of each connection assembly 46, 47, 48, 49 comprises a cylindrical portion 46b′, 47b′, 48b′, 49b′ having a through-hole and being inserted in one of the holes 25, 26, 35, 36 of the coupling portions 23, 24, 33, 34 of the tubular elements 20, 30 and in a respective hole 42, 43, 44, 45 of the coupling ring 41, and a flange (or collar) 46b″, 47b″, 48b″, 49b″ that rests externally on a washer 27, 28, 37, 38 associated with a respective coupling portion 23, 24, 33, 34 of the tubular element 20, 30. Preferably, each bushing 46b, 47b, 48b, 49b is welded to the respective washer 27, 28, 37, 38. The pin 46a, 47a, 48a, 49a associated with the bushing 46b, 47b, 48b, 49b comprises a longitudinal portion 46a′, 47a′, 48a′, 49a′, inserted within the cylindrical portion 46b′, 47b′, 48b′, 49b′ of the respective bushing 46b, 47b, 48b, 49b, and a head 46a″, 47a″, 48a″, 49a″, apt to abut, internally, against the cylindrical portion 46b′, 47b′, 48b′, 49b′ of the respective bushing 46b, 47b, 48b, 49b. Preferably, each pin 46a, 47a, 48a, 49a is welded to the respective bushing 46b, 47b, 48b, 49b.

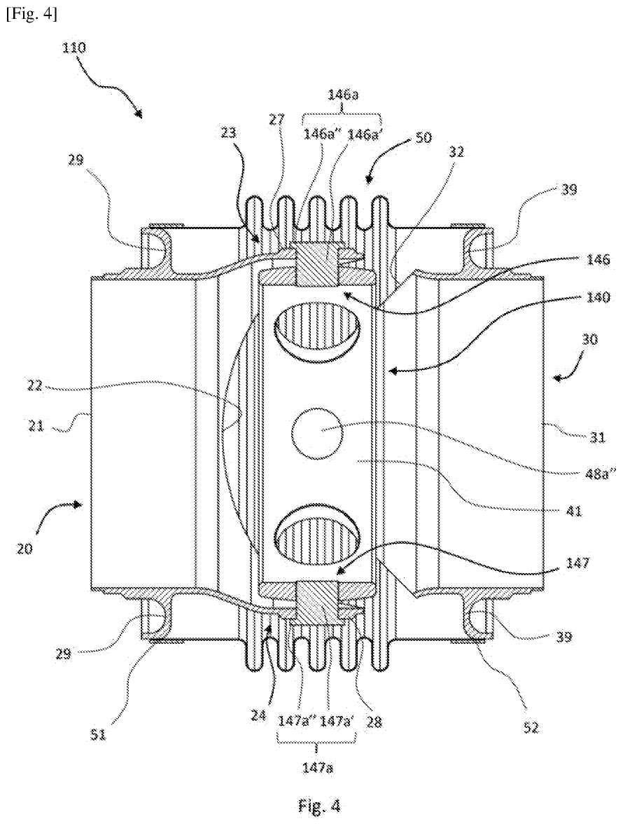

According to a further embodiment of the gimbal compensator 110, shown in FIG. 4, the gimbal compensator 140 comprises connection assemblies 146, 147, 148, 149 comprising solely one bushing 146a, 147a, 148a, 149a, said bushing being, for example, a solid bushing, as shown in the figure, or a hollow one. In particular, each bushing 146a, 147a, 148a, 149a comprises a cylindrical portion 146a′, 147a′, 148a′, 149a′, inserted in one of the holes 25, 26, 35, 36 of the coupling portions 23, 24, 33, 34 of the tubular elements 20, 30 and in a respective hole 42, 43, 44, 45 of the coupling ring 41, and a flange (or collar) 146a″, 147a″, 148a″, 149a″ that rests externally on a washer 27, 28, 37, 38 associated with a respective coupling portion 23, 24, 33, 34 of the tubular element 20, 30. Preferably, each bushing 146a, 147a, 148a, 149a is welded to the respective washer 27, 28, 37, 38.

According to the invention, the washers 27, 28, 37, 38 are made in one piece with the respective tubular elements 20, 30 by the additive manufacturing technique.

The coupling between the first tubular element 20 and the second tubular element 30 by means of said gimbal joint 40 allows said tubular elements 20, 30 to vary, in a known manner, their inclination relative to each other.

The gimbal compensator 10 further comprises a bellows 50, located outside the gimbal joint 40, thereby forming a gimbal compensator 10 of the type with internal bracing, because the gimbal joint 40 is located internally with respect to the bellows 50.

The bellows 50 comprises a first end 51 and a second end 52, said ends being sealingly mounted to a first spacer element 29 and a second space element 39, respectively. Said first and second spacer elements 29, 39 are associated with the first and second tubular elements 20, 30, respectively, and are arranged on the outside thereof in order to space the bellows 50 from the gimbal joint 40.

Each spacer element 29, 39 is an annular element, with a structurally suitable cross-section, for example, with a C”-shaped cross-section facing the first end 21, 31 of the respective tubular elements 20, 30. According to the invention, the spacer elements 29, 39 are made in one piece with the respective tubular elements 20, 30 by the additive manufacturing technique.

According to further embodiments, not shown, the spacer elements have a C”-shaped cross-section facing the second end 22, 32 of the respective tubular elements 20, 30, or a cross-section with different shape, for example, a “Z”-shaped or “I”-shaped cross-section.

From the above description, it will be evident to the person skilled in the art that the gimbal compensator 10 according to the invention makes it possible to effectively achieve the objects set forth above.

It will also be clear to the person skilled in the art that the embodiments as described and illustrated are in no way to be understood in a limiting sense, and numerous variations and modifications within the reach of the person skilled in the art are possible and, in any event, falling within the scope of protection of the present invention as defined by the appended claims.

1. A gimbal compensator (10; 110) for sealingly connecting a pair of pipes in a pipeline, the gimbal compensator (10) comprising:
a first tubular element (20) and a second tubular element (30),
a gimbal joint (40; 140) configured to couple the first tubular element (20) and the second tubular element (30),
a bellows (50), and
a first spacer element (29) and a second spacer element (39), said first and second spacer elements (29, 39) being annular and associated with the first tubular element (20) and the second tubular element (30), respectively,
wherein the bellows (50) is sealingly mounted to the first spacer element (29) and the second spacer element (39), and
wherein each spacer element (29, 39) is made in one piece with the respective tubular element (20, 30) by the additive manufacturing technique.

2. The gimbal compensator (10; 110) according to claim 1,
wherein the gimbal joint (40; 140) comprises a coupling ring (41) having four holes (42, 43, 44, 45), arranged at approximately 90° to each other along the circumferential direction of the ring (41), and four respective connection assemblies (46, 47, 48, 49; 146, 147, 148, 149),
wherein the first tubular element (20) comprises a first coupling portion (23) and a second coupling portion (24), diametrically opposed to each other, each provided with a respective hole (25, 26),
wherein the second tubular element (30) comprises a first coupling portion (33) and a second coupling portion (34), diametrically opposed to each other, each provided with a respective hole (35, 36),
wherein each of said four connection assemblies (46, 47, 48, 49; 146, 147, 148, 149) of the gimbal joint (40; 140) is configured to engage in one of the holes (25, 26, 35, 36) of the coupling portions (23, 24, 33, 34) of the tubular elements (20, 30) and in a respective hole (42, 43, 44, 45) of the coupling ring (41), so as to make the connection between each tubular element (20, 30) and the coupling ring (41),
wherein each of the holes (25, 26, 35, 36) of the coupling portions (23, 24, 33, 34) of the tubular elements (20, 30) is associated with a respective washer (27, 28, 37, 38) apt to cooperate with one respective connection assembly of said connection assemblies (46, 47, 48, 49; 146, 147, 148, 149), and
wherein the washers (27, 28, 37, 38) are made in one piece with the respective tubular elements (20, 30) by the additive manufacturing technique.

3. The gimbal compensator (10) according to claim 2,
wherein each connection assembly (46, 47, 48, 49) comprises a pin (46a, 47a, 48a, 49a) associated with a bushing (46b, 47b, 48b, 49b),
wherein each bushing (46b, 47b, 48b, 49b) comprises a cylindrical portion (46b′, 47b′, 48b′, 49b′), having a through-hole and being inserted in one of the holes (25, 26, 35, 36) of the coupling portions (23, 24, 33, 34) of the tubular elements (20, 30) and in a respective hole (42, 43, 44, 45) of the coupling ring (41), and a flange (46b″, 47b″, 48b″, 49b″) that rests externally on the washer (27, 28, 37, 38) associated with the respective coupling portion (23, 24, 33, 34) of the tubular element (20, 30), and
wherein each pin (46a, 47a, 48a, 49a) comprises a longitudinal portion (46a′, 47a′, 48a′, 49a′), inserted within the cylindrical portion (46b′, 47b′, 48b′, 49b′) of the respective bushing (46b, 47b, 48b, 49b), and a head (46a″, 47a″, 48a″, 49a″), apt to abut, internally, against the cylindrical portion (46b′, 47b′, 48b′, 49b′) of the respective bushing (46b, 47b, 48b, 49b).

4. The gimbal compensator (110) according to claim 2,
wherein each connection assembly (146, 147, 148, 149) comprises exclusively a bushing (146a, 147a, 148a, 149a), and
wherein each bushing (146a, 147a, 148a, 149a) comprises a cylindrical portion (146a′, 147a′, 148a′, 149a′) inserted in one of the holes (25, 26, 35, 36) of the coupling portions (23, 24, 33, 34) of the tubular elements (20, 30) and in a respective hole (42, 43, 44, 45) of the coupling ring (41), and a flange (146a″, 147a″, 148a″, 149a″) that rests externally on the washer (27, 28, 37, 38) associated with the respective coupling portion (23, 24, 33, 34) of the tubular element (20, 30).

5. The gimbal compensator (10; 110) according to claim 4, wherein the bellows (50) is located outside the gimbal joint (40; 140), and wherein the spacer elements (29, 39) are located on the outside of the respective tubular elements (20, 30).

6. The gimbal compensator (10; 110) according to claim 5, wherein each spacer element (29, 39) has a “C”-shaped cross-section facing either a first end (21, 31) of the respective tubular element (20, 30) or a second end (22, 32) of the respective tubular element (20, 30), each of said first ends (21, 31) being connectable to a respective pipe of the pair of pipes to be connected.

7. The gimbal compensator (10; 110) according to claim 5, wherein each spacer element (29, 39) has either a “Z”-shaped or “I”-shaped cross-section.

8. A method of making a gimbal compensator (10; 110) comprising the steps of:
providing a first tubular element (20) and a second tubular element (30), a gimbal joint (40; 140) configured to couple the first tubular element (20) and the second tubular element (30), and a bellows (50),
making the first tubular element (20) in one piece with a respective spacer element (29), by the additive manufacturing technique, and
making the second tubular element (30) in one piece with a respective spacer element (39), by the additive manufacturing technique.

9. The method according to claim 8, further comprising the steps of:
making the first tubular element (20) in one piece with respective washers (27, 28), by the additive manufacturing technique, and
making the second tubular element (30) in one piece with respective washers (37, 38), by the additive manufacturing technique.

10. The gimbal compensator (10; 110) according to claim 3, wherein the bellows (50) is located outside the gimbal joint (40; 140), and wherein the spacer elements (29, 39) are located on the outside of the respective tubular elements (20, 30).

11. The gimbal compensator (10; 110) according to claim 10, wherein each spacer element (29, 39) has a “C”-shaped cross-section facing either a first end (21, 31) of the respective tubular element (20, 30) or a second end (22, 32) of the respective tubular element (20, 30), each of said first ends (21, 31) being connectable to a respective pipe of the pair of pipes to be connected.

12. The gimbal compensator (10; 110) according to claim 10, wherein each spacer element (29, 39) has either a “Z”-shaped or “I”-shaped cross-section.

13. The gimbal compensator (10) according to claim 1,
wherein each connection assembly (46, 47, 48, 49) comprises a pin (46a, 47a, 48a, 49a) associated with a bushing (46b, 47b, 48b, 49b),
wherein each bushing (46b, 47b, 48b, 49b) comprises a cylindrical portion (46b′, 47b′, 48b′, 49b′), having a through-hole and being inserted in one of the holes (25, 26, 35, 36) of the coupling portions (23, 24, 33, 34) of the tubular elements (20, 30) and in a respective hole (42, 43, 44, 45) of the coupling ring (41), and a flange (46b″, 47b″, 48b″, 49b″) that rests externally on the washer (27, 28, 37, 38) associated with the respective coupling portion (23, 24, 33, 34) of the tubular element (20, 30), and
wherein each pin (46a, 47a, 48a, 49a) comprises a longitudinal portion (46a′, 47a′, 48a′, 49a′), inserted within the cylindrical portion (46b′, 47b′, 48b′, 49b′) of the respective bushing (46b, 47b, 48b, 49b), and a head (46a″, 47a″, 48a″, 49a″), apt to abut, internally, against the cylindrical portion (46b′, 47b′, 48b′, 49b′) of the respective bushing (46b, 47b, 48b, 49b).

14. The gimbal compensator (110) according to claim 1,
wherein each connection assembly (146, 147, 148, 149) comprises exclusively a bushing (146a, 147a, 148a, 149a), and
wherein each bushing (146a, 147a, 148a, 149a) comprises a cylindrical portion (146a′, 147a′, 148a′, 149a′) inserted in one of the holes (25, 26, 35, 36) of the coupling portions (23, 24, 33, 34) of the tubular elements (20, 30) and in a respective hole (42, 43, 44, 45) of the coupling ring (41), and a flange (146a″, 147a″, 148a″, 149a″) that rests externally on the washer (27, 28, 37, 38) associated with the respective coupling portion (23, 24, 33, 34) of the tubular element (20, 30).

15. The gimbal compensator (10; 110) according to claim 1, wherein the bellows (50) is located outside the gimbal joint (40; 140), and wherein the spacer elements (29, 39) are located on the outside of the respective tubular elements (20, 30).

16. The gimbal compensator (10; 110) according to claim 1, wherein each spacer element (29, 39) has a “C”-shaped cross-section facing either a first end (21, 31) of the respective tubular element (20, 30) or a second end (22, 32) of the respective tubular element (20, 30), each of said first ends (21, 31) being connectable to a respective pipe of the pair of pipes to be connected.

17. The gimbal compensator (10; 110) according to claim 1, wherein each spacer element (29, 39) has either a “Z”-shaped or “I”-shaped cross-section.
